(19) United States
(12) Patent Application Publication
(10) Pub. No.: US 2022/0324022 A1
(43) Pub. Date: Oct. 13, 2022

(54) MICROWAVE PLASMA PROCESSING OF SPHEROIDIZED COPPER OR OTHER METALLIC POWDERS

(71) Applicant: 6K Inc., North Andover, MA (US)

(72) Inventor: Sunil Bhalchandra Badwe, Export, PA (US)

(21) Appl. No.: 17/655,873

(22) Filed: Mar. 22, 2022

Related U.S. Application Data
(60) Provisional application No. 63/200,848, filed on Mar. 31, 2021.

(51) Int. Cl. B22F 9/14; B22F 1/065; B22F 9/04

(52) U.S. Cl. CPC B22F 9/14; B22F 1/065; B22F 9/04; B22F 2301/10; B22F 2304/10; B22F 2009/041

(57) ABSTRACT

Disclosed herein are systems and methods for synthesis of spheroidized metal or metal alloy powders using microwave plasma processing. In some embodiments, the metal or metal alloy may comprise a highly ductile, soft, and/or malleable metal or metal alloy such that machining of the metal or metal alloy is difficult or impossible. In some embodiments, a volatile material is dispersed within the metal or metal alloy feedstock to enable machining and pre-processing of the feedstock. In some embodiments, the dispersed volatile material alters the physical properties of the feedstock, such that the metal or metal alloy, which is difficult to machine due to high ductility, softness, and/or malleability, is easily machined in a pre-processing step. In some embodiments, the pre-processed feedstock, can be fed into a plasma processing apparatus. In some embodiments, the volatile material dispersed within the feedstock material may be vaporized upon exposure to the microwave plasma apparatus. In some embodiments, plasma processing of the pre-processed feedstock material may synthesize pure, spheroidized metal or metal alloy particles, with substantially no contamination of the volatile material ion the final product.

### INCORPORATION BY REFERENCE TO ANY PRIORITY APPLICATIONS

This application claims the priority benefit under 35 U.S.C. § 119(e) of U.S. Provisional Application No. 63/200,848, filed Mar. 31, 2022, the entire disclosure of which is incorporated herein by reference. Any and all applications for which a foreign or domestic priority claim is identified in the Application Data Sheet as filed with the present application are hereby incorporated by reference under 37 CFR 1.57.

### BACKGROUND

### Field

Some embodiments of the present disclosure are directed to systems and methods for synthesizing metal, particularly copper or other soft, ductile, and/or malleable metals, into spherical or spheroidal powder products from feedstock materials using plasma processing.

### Description

An important aspect of preparing some forms of industrial powders is the spheroidization process, which transforms irregularly shaped or angular powders into spherical low-porosity particles. Such spherical powders exhibit superior properties in applications such as injection molding, thermal spray coatings, additive manufacturing, etc.

Creating spheroidal metallic powders, especially metallic powders comprising soft, ductile, and/or malleable metals can pose a number of challenges. Achieving the desired spheroidal shape, the desired level of porosity (e.g., no porosity to very porous), and the desired composition and microstructure can be difficult. Additionally, such metals can be difficult to grind, mill, or otherwise machine.

To be useful in additive manufacturing (AM) or powdered metallurgy (PM) applications that require high powder flow, metal powder particles should exhibit a spherical shape, which can be achieved through the process of spheroidization. This process involves the melting of particles in a hot environment whereby surface tension of the liquid metal shapes each particle into a spherical geometry, followed by cooling and re-solidification.

Existing systems and processes for synthesizing spheroidal metallic powders from soft, ductile, and/or malleable metal feedstocks are deficient. Thus, new systems and methods for spheroidization of such materials are needed.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments herein are directed to a method for manufacturing a copper spheroidized powder, the method comprising: providing a copper feedstock; dispersing a volatile material within the copper feedstock by melting the copper feedstock and mixing the melted copper feedstock with the volatile material; machining the copper feedstock to produce metallic particles within a range of particle volumes pre-determined to be suitable for use as a feedstock in a microwave plasma process; and applying the microwave plasma process to the metallic particles such that the volatile material is vaporized and the copper spheroidized powder is formed.

In some embodiments, the method further comprises cooling the melted copper feedstock prior to machining the copper feedstock. In some embodiments, the method further comprises casting the copper feedstock into a pre-determined shape prior to applying the microwave plasma process. In some embodiments, the determined range of particle volumes is between 15 and 63 microns. In some embodiments, the applying the microwave plasma process to the metallic particles comprises introducing the metallic particles into an exhaust of a microwave plasma torch or into a plume of the microwave plasma torch. In some embodiments, the copper feedstock is machined by milling or crushing the copper feedstock without embrittling the copper feedstock. In some embodiments, the dispersed volatile material alters the physical properties of the copper feedstock to facilitate the machining of the copper feedstock.

Some embodiments herein are directed to a method for manufacturing a copper spheroidized powder, the method comprising: introducing metallic particles obtained by machining into a microwave plasma torch, the metallic particles comprising: copper; and a volatile material dispersed within the copper; melting and spheroidizing the metallic particles within the microwave plasma torch to vaporize the volatile material and form the copper spheroidized powder.

In some embodiments, the method further comprises melting the copper and mixing the volatile materials with the melted copper to form the metallic particles. In some embodiments, the method further comprises cooling the metallic particles prior to machining the metallic particles. In some embodiments, the method further comprises casting the metallic particles into a pre-determined shape prior to introducing the metallic particles into the microwave plasma torch. In some embodiments, the metallic particles obtained by machining comprising milling or crushing the metallic particles without embrittling the metallic particles. In some embodiments, the metallic particles are only partially surface melted by the microwave plasma torch. In some embodiments, the dispersed volatile material alters the physical properties of the metallic particles to facilitate the machining of the metallic particles.

In some embodiments, the copper spheroidized powder comprises particles with a median sphericity of at least 0.75. In some embodiments, the copper spheroidized powder comprises particles with a median sphericity of at least 0.90. In some embodiments, the spheroidized metal or metal alloy powder has a particle size distribution of between 5 and 45 microns at a low end of the particle size distribution range and between 15 and 105 microns at a high end of the particle size distribution range.

Some embodiments herein are directed to a spheroidized powder manufactured according to a method comprising: providing a copper feedstock; dispersing a volatile material within the copper feedstock by melting the copper feedstock and mixing the melted copper feedstock with the volatile material; machining the copper feedstock to produce metallic particles within a range of particle volumes pre-determined to be suitable for use as a feedstock in a microwave plasma process; and applying the microwave plasma process to the metallic particles such that the volatile material is vaporized and the copper spheroidized powder is formed.

Some embodiments herein are directed to a spheroidized powder manufactured according to a method comprising: introducing metallic particles obtained by machining into a microwave plasma torch, the metallic particles comprising: copper; and a volatile material dispersed within the copper; and melting and spheroidizing the metallic particles within the microwave plasma torch to vaporize the volatile material and form the copper spheroidized powder.

In some embodiments, the spheroidized powder of claim 18, wherein the spheroidized powder comprises particles with a median sphericity of at least 0.75. In some embodiments, the spheroidized powder of claim 18, wherein the spheroidized powder comprises particles with a median sphericity of at least 0.90.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates an example flowchart of a process for producing a spheroidized metal powder material according to some embodiments described herein.

FIG. 2 illustrates an embodiment of a top feeding microwave plasma torch that can be used in the production of powders, according to embodiments of the present disclosure.

FIGS. 3A-3B illustrate embodiments of a microwave plasma torch that can be used in the production of powders, according to a side feeding hopper embodiment of the present disclosure.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

Disclosed herein are embodiments of methods, devices, and systems for spheroidization of feedstock materials using microwave plasma processing. Each different feedstock material has its own critical, specialized, and unique requirements for preprocessing the initial feedstock as well as the processing in a microwave plasma torch in order to achieve a desired spheroidization. Specifically, the feedstock materials disclosed herein pertain to soft, ductile, and/or malleable metal or metal alloy feed materials. In some embodiments, the feedstocks may require initial pre-processing or specific plasma processing to synthesize spheroidized metal particles. As disclosed herein, processing in a microwave plasma torch can include feeding the feedstock into a microwave plasma torch, a plasma plume of the microwave plasma torch, and/or an exhaust of the microwave plasma torch. The location may vary depending on the type of feedstock used. Further, the feedstock can be selected based on different requirements. Examples of requirements are aspect ratio, particle size distribution (PSD), chemistry, density, diameter, sphericity, oxygenation, hardness, and ductility.

Some embodiments herein are directed to systems and methods for using microwave plasma processing to synthesize spheroidal metal powders from metal or metal alloy feedstocks, wherein the metal or metal alloy has physical properties such as high ductility, softness, and/or malleability. In some embodiments, it can be very difficult to attain a usable feedstock comprising such metals for plasma processing. Typically, for metals having relatively low ductility and high hardness, a plasma processing feedstock may be obtained by machining (e.g., milling, slotting, drilling, tapping, counterboring, chamfering, threading, knurling, brazing, grooving, trimming, etc.) metal in the form of, for example, scrap metal. Metals or metal alloys having high ductility and low hardness, on the other hand are very difficult to machine. For this reason, in some industries, alloys are formed in place of pure metal to improve machinability. However, in some cases, pure spheroidized metal powder is needed for certain applications, such as AM or PM applications. Thus, new systems and methods for preparing feedstock for plasma processing comprising high ductility, low hardness metals or metal alloys are needed. Examples of such metals or metal alloys include low carbon steels, stainless steels, nickel alloys, titanium, and copper.

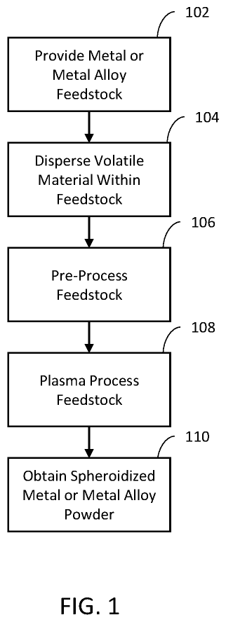

FIG. 1 illustrates an example flowchart of a process for producing a spheroidized metal powder material according to some embodiments described herein. In some embodiments, at 102, a metal or metal alloy feedstock is provided. In some embodiments, the metal or metal alloy may comprise a highly ductile, soft, and/or malleable metal or metal alloy such that machining of the metal or metal alloy is difficult or impossible.

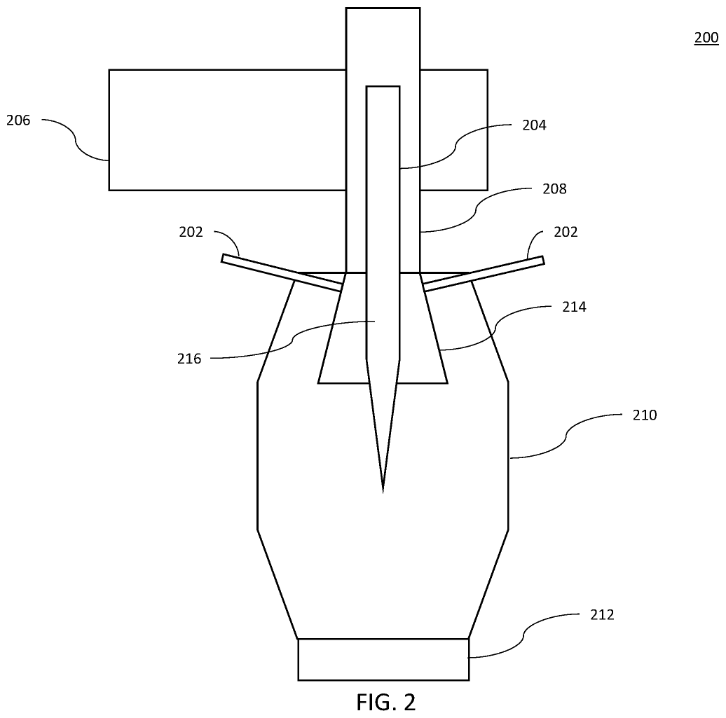

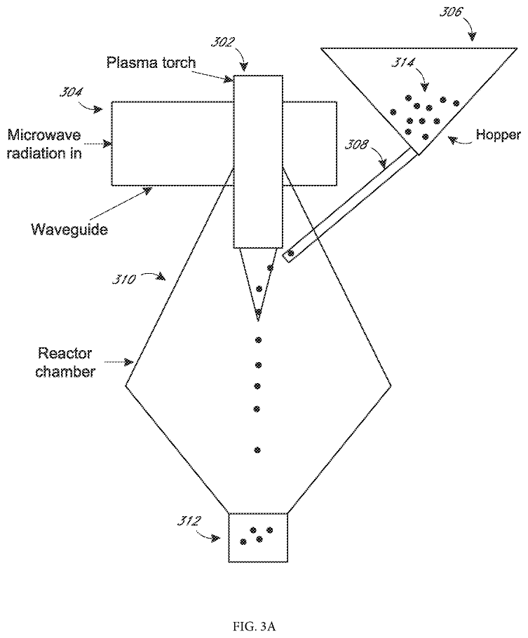

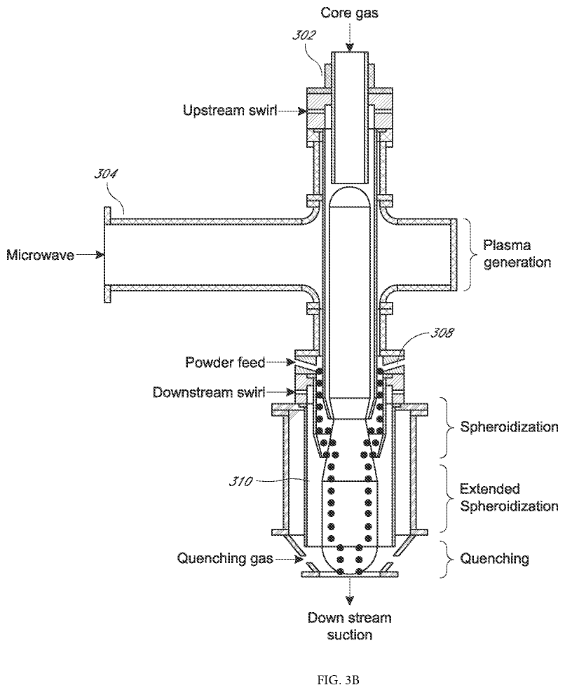

In some embodiments, the metal or metal alloy feedstock comprises low carbon steels, stainless steels, nickel alloys, titanium, or copper. In some embodiments, at 104, a volatile material is dispersed within the metal or metal alloy feedstock. In some embodiments, the dispersed volatile material alters the physical properties of the feedstock, such that the metal or metal alloy, which is typically difficult to machine due to high ductility, softness, and/or malleability, is easily machined in a pre-processing step. As such, the feedstock having a volatile material dispersed therein can be more readily pre-processed at 106 by milling or other machining to achieve a desired particle shape, aspect ratio and/or size distribution. In some embodiments, at 108, the pre-processed feedstock, can be fed into a plasma processing apparatus, such as those illustrated in FIG. 2 and FIGS. 3A-3B, for microwave plasma processing. In some embodiments, the volatile material dispersed within the feedstock material may be vaporized upon exposure to the microwave plasma apparatus. In some embodiments, at 110, plasma processing of the pre-processed feedstock material may synthesize pure, spheroidized metal or metal alloy particles, with substantially no contamination of the volatile material ion the final product.

In some embodiments, the volume distribution of the feedstock can be the same as the final spheroidized powder. In some embodiments, the overall volume of the feedstock can be the generally the same as the final spheroidized powder. In some embodiments, the overall volume of the feedstock can be within 1%, 2%, 3%, 4%, 5%, 10%, 15%, or 20% (or about 1%, about 2%, about 3%, about 4%, about 5%, about 10%, about 15%, or about 20%) of the final spheroidized powder.

In some embodiments, the feedstock metal or metal alloy may be pre-processed before introduction into the plasma process. For example, the feedstock metal or metal alloy may be sieved to remove large agglomerations and selected to the desired size to be processed in the plasma. In some embodiments, the feedstock metal or metal alloy may be cleaned with water, surfactant, detergent, solvent, or any other chemical such as acids to remove contamination. In some embodiments, the feedstock metal or metal alloy may be magnetically cleaned if the metal or metal alloy is contaminated with any magnetic material. In some embodiments, the cleaning removes contaminants such as ceramics and oils. In some embodiments, the feedstock metal or metal alloy can be pre-treated to de-oxidize it. In some embodiments, the feedstock metal or metal alloy can be de-dusted to remove fines.

In some embodiments, metals or metal alloys as used herein may include low carbon steels, stainless steels, nickel alloys, titanium, or copper. Titanium or copper can be particularly problematic for milling as they are highly ductile, and thus would merely bend or change shape, and would not be broken down properly into a powder without embrittling, such as through hydrogenation or cryogenics. However, embodiments of the disclosure can mill copper, copper alloys, titanium, or titanium alloys without such an embrittling process.

In some embodiments, the methods herein may include an analysis of the inter-relationship between the selection of feedstock, the feedstock size/aspect ratio, a machining approach that forms the feedstock into a material suitable for plasma processing, and a final desired particle volume, in order to create a desired particle size distribution for specific applications. In some embodiments, the final specific application can be, for example, laser bed fusion which has a particle size distribution (PSD) of 15-45 microns (or about 15 to about 45 microns), or 15-63 microns (or about 15 to about 63 microns) or 20-63 microns (or about 20-about 63 microns), electron beam processing which can have a particle size distribution of 45-105 microns (or about 45 to about 105 microns) or 105-150 microns (or about 105 to about 150 microns), or metal injection molding (MIM). In some embodiments, the PSD can be expressed as the D50 of the particles in the feedstock. In some embodiments, the feedstock is processed through jet milling, wet milling, or ball milling. In some embodiments, the PSD of the feedstock is 15-15 microns, 15-45 microns, 20-63 microns, 45-105 microns, or 105 to 150 microns. The PSD can be adjusted depending on the final application powder processing technology such as laser powder bed fusion, direct energy deposition, binder jet printing, metal injection molding, and hot isostatic pressing.

In some embodiments, the feedstock is tailored to have a volume distribution approximately equal to the volume distribution of the desired PSD of processed powder. Volume is calculated based on 4/3*π*r³ where ‘r’ is the radius of the processed powder. In some embodiments, a majority of the feedstock particles has a volume within a range of about 4/3 π (x/2)³ and about 4/3 π (y/2)³, wherein x is the low end of the desired particle size distribution and y is the high end of the desired particle size distribution. In some embodiments, substantially all of the feedstock particles have a volume within a range of about 4/3 π (x/2)³ and 4/3 π (y/2)³. In one example, the volume distribution of the preprocessed and processed feedstock can be between about 65.45 μm3 and about 47,712.94 μm3, corresponding to a desired particle size distribution of 5 to 15 microns for the processed powder. In some embodiments, an average or median aspect ratio, collectively, of preprocessed feedstock can be between 2:1 and 200:1, between 3:1 and 200:1, between 4:1 and 200:1, or between 5:1 and 200:1. However, any of the disclosed ratios/diameters can be used for the volume calculation. After processing, the particle size distribution in one example can be 5 to 45 microns. Other particle size distributions are also contemplated, including but not limited to particle size distributions of between 5 and 45 microns at a low end of the PSD range and between 15 and 105 microns at a high end of the PSD range (e.g., 5 to 15 microns, 15 to 45 microns, 45 to 105 microns).

Particle size distribution has a direct influence on powder flowability and the ability to provide a uniform, powder bed density. This in turn determines the energy input needed to process the powder grains and affects the surface finish. For example, a spheroidized powder usable in AM process may have a particle size distribution between about 15-45 microns, about 20-63 microns, or about 45-106 microns. However, according to the methods and systems described herein, a spheroidized powder may comprise a particle size distribution in the nanometer range to the millimeter range.

Furthermore, to be useful in additive manufacturing or powder metallurgy (PM) applications that require high powder flow, metal powder particles should exhibit a spherical shape, which can be achieved through the process of plasma spheroidization. This process involves the full melting, surface melting or partial melting of particles in a hot environment whereby surface tension of the liquid metal shapes each particle into a spherical geometry, followed by cooling and re-solidification.

In some embodiments, the final particles achieved by the plasma processing can be spherical, spheroidized, or spheroidal, terms that can be used interchangeably. Advantageously, by using the critical and specific disclosure relevant to each of the different feedstocks disclosed, all of the feedstocks can be transformed into the spherical powders.

Embodiments of the present disclosure are directed to producing particles that are substantially spheroidized or have undergone significant spheroidization. In some embodiments, spherical, spheroidal or spheroidized particles refer to particles having a sphericity greater than a certain threshold. Particle sphericity can be calculated by calculating the surface area of a sphere A_{s,ideal} with a volume matching that of the particle, V using the following equation:

$${r}_{ideal} = \sqrt[2]{\frac{3 V}{4 π}} \\ {A}_{s , ideal} = 4 {π r}_{ideal}^{2}$$

The idealized surface area can be compared with the measured surface area of the particle, A_{s,actual}:

$$sphericity = \frac{{A}_{s , ideal}}{{A}_{s , actual}} .$$

In some embodiments, particles can have a sphericity of greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, particles can have a sphericity of 0.75 or greater or 0.91 or greater (or about 0.75 or greater or about 0.91 or greater). In some embodiments, particles can have a sphericity of less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a particle is considered to be spherical, spheroidal or spheroidized if it has a sphericity at or above any of the aforementioned sphericity values, and in some preferred embodiments, a particle is considered to be spherical if its sphericity is at or about 0.75 or greater or at or about 0.91 or greater.

In some embodiments, a median sphericity of all particles within a given powder can be greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, a median sphericity of all particles within a given powder can be less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a powder is considered to be spheroidized if all or a threshold percentage (as described by any of the fractions below) of the particles measured for the given powder have a median sphericity greater than or equal to any of the aforementioned sphericity values, and in some preferred embodiments, a powder is considered to be spheroidized if all or a threshold percentage of the particles have a median sphericity at or about 0.75 or greater or at or about 0.91 or greater.

In some embodiments, the fraction of particles within a powder that can be above a given sphericity threshold, such as described above, can be greater than 50%, 60%, 70%, 80%, 90%, 95%, or 99% (or greater than about 50%, about 60%, about 70%, about 80%, about 90%, about 95%, or about 99%). In some embodiments, the fraction of particles within a powder that can be above a given sphericity threshold, such as described above, can be less than 50%, 60%, 70%, 80%, 90%, 95%, or 99% (or less than about 50%, about 60%, about 70%, about 80%, about 90%, about 95%, or about 99%).

Particle size distribution and sphericity may be determined by any suitable known technique such as by SEM, optical microscopy, dynamic light scattering, laser diffraction, manual measurement of dimensions using an image analysis software, for example from about 15-30 measures per image over at least three images of the same material section or sample, and any other techniques.

FIG. 2 illustrates an embodiment of a microwave plasma torch 200 that can be used in the production of materials according to some embodiments herein. In some embodiments, a feedstock can be introduced, via one or more feedstock inlets 202, into a microwave plasma 204. In some embodiments, an entrainment gas flow and/or a sheath flow may be injected into the microwave plasma applicator 205 to create flow conditions within the plasma applicator prior to ignition of the plasma 204 via microwave radiation source 206. In some embodiments, the entrainment flow and sheath flow are both axis-symmetric and laminar, while in other embodiments the gas flows are swirling. In some embodiments, the feedstock may be introduced into the microwave plasma torch 200, where the feedstock may be entrained by a gas flow that directs the materials toward the plasma 204.

The gas flows can comprise a noble gas column of the periodic table, such as helium, neon, argon, etc. Although the gases described above may be used, it is to be understood that a variety of gases can be used depending on the desired material and processing conditions. In some embodiments, within the microwave plasma 204, the feedstock may undergo a physical and/or chemical transformation. Inlets 202 can be used to introduce process gases to entrain and accelerate the feedstock towards plasma 204. In some embodiments, a second gas flow can be created to provide sheathing for the inside wall of a plasma applicator 204 and a reaction chamber 210 to protect those structures from melting due to heat radiation from plasma 204.

Various parameters of the microwave plasma 204, as created by the plasma applicator 205, may be adjusted manually or automatically in order to achieve a desired material. These parameters may include, for example, power, plasma gas flow rates, type of plasma gas, presence of an extension tube, extension tube material, level of insulation of the reactor chamber or the extension tube, level of coating of the extension tube, geometry of the extension tube (e.g. tapered/stepped), feed material size, feed material insertion rate, feed material inlet location, feed material inlet orientation, number of feed material inlets, plasma temperature, residence time and cooling rates. The resulting material may exit the plasma into a sealed chamber 212 where the material is quenched then collected.

In some embodiments, the feedstock is injected after the microwave plasma applicator for processing in the “plume” or “exhaust” of the microwave plasma torch. Thus, the plasma of the microwave plasma torch is engaged at the exit end of the plasma torch core tube 208, or further downstream. In some embodiments, adjustable downstream feeding allows engaging the feedstock with the plasma plume downstream at a temperature suitable for optimal melting of feedstock through precise targeting of temperature level and residence time. Adjusting the inlet location and plasma characteristics may allow for further customization of material characteristics. Furthermore, in some embodiments, by adjusting power, gas flow rates, pressure, and equipment configuration (e.g., introducing an extension tube), the length of the plasma plume may be adjusted.

In some embodiments, feeding configurations may include one or more individual feeding nozzles surrounding the plasma plume. The feedstock may enter the plasma from any direction and can be fed in 360° around the plasma depending on the placement and orientation of the inlets 202. Furthermore, the feedstock may enter the plasma at a specific position along the length of the plasma 204 by adjusting placement of the inlets 202, where a specific temperature has been measured and a residence time estimated for providing the desirable characteristics of the resulting material.

In some embodiments, the angle of the inlets 202 relative to the plasma 204 may be adjusted, such that the feedstock can be injected at any angle relative to the plasma 204. For example, the inlets 202 may be adjusted, such that the feedstock may be injected into the plasma at an angle of about 0 degrees, about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees relative to the direction of the plasma 204, or between any of the aforementioned values.

In some embodiments, implementation of the downstream injection method may use a downstream swirl or quenching. A downstream swirl refers to an additional swirl component that can be introduced downstream from the plasma applicator to keep the powder from the walls of the applicator 205, the reactor chamber 210, and/or an extension tube 214.

In some embodiments, the length of a reaction chamber 210 of a microwave plasma apparatus may be about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

In some embodiments, the length of the plasma 204, which may be extended by adjusting various processing conditions and equipment configurations, may be about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

FIGS. 3A-3B illustrate an exemplary microwave plasma torch that includes a side feeding hopper rather than the top feeding hopper shown in the embodiment of FIG. 2 thus allowing for downstream feeding. Thus, in this implementation the feedstock is injected after the microwave plasma torch applicator for processing in the “plume” or “exhaust” of the microwave plasma torch. Thus, the plasma of the microwave plasma torch is engaged at the exit end of the plasma torch to allow downstream feeding of the feedstock, as opposed to the top-feeding (or upstream feeding) discussed with respect to FIG. 2. This downstream feeding can advantageously extend the lifetime of the torch as the hot zone is preserved indefinitely from any material deposits on the walls of the hot zone liner. Furthermore, it allows engaging the plasma plume downstream at temperature suitable for optimal melting of powders through precise targeting of temperature level and residence time. For example, there is the ability to dial the length of the plume using microwave powder, gas flows, and pressure in the quenching vessel that contains the plasma plume.

Generally, the downstream spheroidization method can utilize two main hardware configurations to establish a stable plasma plume which are: annular torch, such as described in U.S. Pat. Pub. No. 2018/0297122, or swirl torches described in U.S. Pat. No. 8,748,785 B2 and U.S. Pat. No. 9,932,673 B2. Both FIG. 2A and FIG. 2B show embodiments of a method that can be implemented with either an annular torch or a swirl torch. A feed system close-coupled with the plasma plume at the exit of the plasma torch is used to feed powder axisymmetrically to preserve process homogeneity. Other feeding configurations may include one or several individual feeding nozzles surrounding the plasma plume.

The feed materials 314 can be introduced into a microwave plasma torch 302. A hopper 306 can be used to store the feed material 314 before feeding the feed material 314 into the microwave plasma torch 302, plume, or exhaust. In alternative embodiments, the feedstock can be injected along the longitudinal axis of the plasma torch. The microwave radiation can be brought into the plasma torch through a waveguide 304. The feed material 314 is fed into a plasma chamber 310 and is placed into contact with the plasma generated by the plasma torch 302. When in contact with the plasma, plasma plume, or plasma exhaust, the feed material melts. While still in the plasma chamber 310, the feed material 314 cools and solidifies before being collected into a container 312. Alternatively, the feed material 314 can exit the plasma chamber 310 while still in a melted phase and cool and solidify outside the plasma chamber. In some embodiments, a quenching chamber may be used, which may or may not use positive pressure. While described separately from FIG. 2, the embodiments of FIGS. 3A-3B are understood to use similar features and conditions to the embodiment of FIG. 2.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A method for manufacturing a copper spheroidized powder, the method comprising:
providing a copper feedstock;
dispersing a volatile material within the copper feedstock by melting the copper feedstock and mixing the melted copper feedstock with the volatile material;
machining the copper feedstock to produce metallic particles within a range of particle volumes pre-determined to be suitable for use as a feedstock in a microwave plasma process; and
applying the microwave plasma process to the metallic particles such that the volatile material is vaporized and the copper spheroidized powder is formed.

2. The method of claim 1, further comprising cooling the melted copper feedstock prior to machining the copper feedstock

3. The method of claim 1, further comprising casting the copper feedstock into a pre-determined shape prior to applying the microwave plasma process.

4. The method of claim 1, wherein the determined range of particle volumes is between 15 and 63 microns.

5. The method of claim 1, wherein the applying the microwave plasma process to the metallic particles comprises introducing the metallic particles into an exhaust of a microwave plasma torch or into a plume of the microwave plasma torch.

6. The method of claim 1, wherein the copper feedstock is machined by milling or crushing the copper feedstock without embrittling the copper feedstock.

7. The method of claim 1, wherein the dispersed volatile material alters the physical properties of the copper feedstock to facilitate the machining of the copper feedstock.

8. A method for manufacturing a copper spheroidized powder, the method comprising:
introducing metallic particles obtained by machining into a microwave plasma torch, the metallic particles comprising:
copper; and
a volatile material dispersed within the copper;
melting and spheroidizing the metallic particles within the microwave plasma torch to vaporize the volatile material and form the copper spheroidized powder.

9. The method of claim 8, further comprising melting the copper and mixing the volatile materials with the melted copper to form the metallic particles.

10. The method of claim 8, further comprising cooling the metallic particles prior to machining the metallic particles.

11. The method of claim 8, further comprising casting the metallic particles into a pre-determined shape prior to introducing the metallic particles into the microwave plasma torch.

12. The method of claim 8, wherein the metallic particles are obtained by machining comprising milling or crushing the metallic particles without embrittling the metallic particles.

13. The method of claim 8, wherein the metallic particles are only partially surface melted by the microwave plasma torch.

14. The method of claim 8, wherein the dispersed volatile material alters the physical properties of the metallic particles to facilitate the machining of the metallic particles.

15. The method of claim 8, wherein the copper spheroidized powder comprises particles with a median sphericity of at least 0.75.

16. The method of claim 8, wherein the copper spheroidized powder comprises particles with a median sphericity of at least 0.90.

17. The method of claim 8, wherein the spheroidized metal or metal alloy powder has a particle size distribution of between 5 and 45 microns at a low end of the particle size distribution range and between 15 and 105 microns at a high end of the particle size distribution range.

18. A spheroidized powder manufactured according to a method comprising:
introducing metallic particles obtained by machining into a microwave plasma torch, the metallic particles comprising:
copper; and
a volatile material dispersed within the copper; and
melting and spheroidizing the metallic particles within the microwave plasma torch to vaporize the volatile material and form the copper spheroidized powder.

19. The spheroidized powder of claim 18, wherein the spheroidized powder comprises particles with a median sphericity of at least 0.75.

20. The spheroidized powder of claim 18, wherein the spheroidized powder comprises particles with a median sphericity of at least 0.90.
